(19) United States
(12) Patent Application Publication
(10) Pub. No.: US 2025/0204612 A1
(43) Pub. Date: Jun. 26, 2025

(54) A TESTING EQUIPMENT AND METHOD FOR TESTING A SUSCEPTOR ARRANGEMENT IN SIMULATED HEATING CONDITIONS

(71) Applicant: PHILIP MORRIS PRODUCTS S.A., Neuchatel (CH)

(72) Inventors: Soon Leong Chew, Singapore (SG); Daniele Sanna, Marin-Epagnier (CH); Enrico Stura, Palezieux-Village (CH)

(21) Appl. No.: 18/702,023

(22) PCT Filed: Oct. 24, 2022
(86) PCT No.: PCT/EP2022/079524

§ 371 Date: Apr. 17, 2024

(30) Foreign Application Priority Data
Oct. 25, 2021 (EP) 21204408.5

(51) Int. Cl. A24F 40/80; A24F 40/465; A24F 40/50

(52) U.S. Cl. CPC A24F 40/80; A24F 40/465; A24F 40/50

(57) ABSTRACT

The present invention relates to a testing equipment and method for testing a susceptor arrangement in simulated heating conditions of a heated susceptor arrangement arranged in an aerosol-generating device during a user experience. The testing equipment comprises a holder module comprising a holder for receiving a susceptor arrangement to be tested, a control module comprising an inductive heating arrangement and a measurement device comprising a control circuit, wherein the inductive heating arrangement is configured to generate an alternating magnetic field for inductively heating a susceptor arrangement. The measurement device is configured to determine values associated to physical characteristics of the susceptor arrangement from measurements related to a load applied to the control circuit responsive to a susceptor arrangement in operational communication with the inductive heating arrangement, and the control circuit is configured to power the inductive heating arrangement for one test cycle or several subsequent test cycles of the susceptor arrangement and configured to determine if determined values associated to physical characteristics of the susceptor arrangement correspond to predetermined susceptor values.

The present invention relates to a testing equipment and method for testing a susceptor arrangement in simulated heating conditions of a heated susceptor arrangement arranged in an aerosol-generating device during a user experience.

Articles comprising an aerosol-forming substrate and a heating element in the form of a susceptor for heating the substrate to generate aerosol are generally known from the prior art. Material parameters of the susceptor need to be within very specific ranges for an optimized performance of the susceptor and according aerosol generation. However, in particular in multi-layer susceptor arrangements physical material parameters of the susceptor may be too complex to be linked to requested or necessary susceptor performance. Thus, individual material parameters provided, for example, by a susceptor supplier are often not sufficient to characterize a heating performance of the multi-layer susceptor arrangement.

Therefore, there is a need for a testing equipment and testing method allowing to test a susceptor arrangement, in particular a multi-layer susceptor arrangement, in simulated real conditions.

According to the invention there is provided a testing equipment for testing a susceptor arrangement in simulated heating conditions of a heated susceptor arrangement arranged in an aerosol-generating device during a user experience. The testing equipment comprises a holder module comprising a holder for receiving a susceptor arrangement to be tested, and a control module comprising an inductive heating arrangement and a measurement device comprising a control circuit. The inductive heating arrangement is configured to generate an alternating magnetic field for inductively heating a susceptor arrangement. The measurement device is configured to determine values associated to physical characteristics of the susceptor arrangement from measurements related to a load applied to the control circuit responsive to a susceptor arrangement in operational communication with the inductive heating arrangement. The control circuit is configured to power the inductive heating arrangement for one test cycle or for several subsequent test cycles of the susceptor arrangement and configured to determine if determined values associated to physical characteristics of the susceptor arrangement correspond to predetermined susceptor values, preferably to predetermined susceptor values of a predefined susceptor arrangement in a predefined user experience.

It has been found that when testing a susceptor arrangement in simulated heating conditions, and comparing the test results with desired heating characteristics of a susceptor arrangement during a user experience, no detailed material characteristics of a susceptor arrangement need to be known. The desired heating characteristics correspond to predetermined susceptor values of a susceptor arrangement arranged in an aerosol-forming substrate when being heated in an inductive heating device and according a user experience. The predetermined susceptor values are preferably and in particular predetermined electrical conductance values, more specifically changes in electrical conductance values or rates of changes in electrical conductance.

Typically, the measurement device is configured to determine values associated to physical characteristics of the susceptor arrangement from measurements of current and voltage drawn by the inductive heating device. The susceptor arrangement represents a load to the control circuit and the measurements are responsive to the susceptor arrangement in operational communication with the inductive heating arrangement. Depending on changing physical characteristics of the susceptor arrangement at different temperatures and times during a test cycle, in particular during heating of the susceptor arrangement, the load applied to the control circuit varies and physical values, in particular apparent electrical resistance or apparent electrical conductance values, of the susceptor arrangement may be determined from current and voltage drawn by the inductive heating device.

Preferably, the control module is configured to output acceptance of a tested susceptor assembly, if predetermined susceptor values are reached or to output rejection of a tested susceptor assembly, if predetermined susceptor values are not reached.

Preferably, predetermined values associated to physical characteristics of the susceptor arrangement comprise a maximum and a minimum in electrical conductance per test cycle at predefined times during a test cycle, preferably during a heating period of the test cycle.

Acceptance or rejection of a tested susceptor assembly may be determined upon different test results. For example, in some embodiments the control module may be configured to compare determined values associated to physical characteristics of the susceptor arrangement per each test cycle with predetermined susceptor values. In some other embodiments the control module is configured to average determined values associated to physical characteristics of the susceptor arrangement over two, several or over all performed test cycles and to compare said averaged susceptor values with predetermined susceptor values. Running several tests, thus running at least two, preferably, three to five tests, and averaging the test results may reduce the number of presumably defective susceptor arrangements due to a single test result being outside of a predefined threshold of a predetermined susceptor value.

A predefined set of thresholds within which a determined set of values associated to physical characteristics of the susceptor arrangement may be, or a predefined set of thresholds for an acceptable deviation from a set of predetermined susceptor values may be defined depending on required or desired precision of a heating characteristics of a susceptor arrangement.

A predefined threshold is preferably between 5 percent and 30 percent of a predetermined value. A predefined threshold is preferably below 10 percent of a predetermined value. Thus, a value of a tested and measured susceptor arrangement may deviate between 5 percent and 30 percent or at a maximum of plus or minus 10 percent from a predetermined value.

Preferably, values associated to physical characteristics of the susceptor arrangement are permeability, apparent electrical resistance or apparent electrical conductance values and the predetermined susceptor values are predetermined permeability, electrical resistance or electrical conductance values, Most preferably, values associated to physical characteristics of the susceptor arrangement are apparent electrical conductance values and the predetermined susceptor values are predetermined electrical conductance values.

The measurement device may comprise a current measurement device for determining a DC current drawn by the inductive heating arrangement from a DC power supply of the device, and a voltage measurement device for determining a DC voltage supplied to the inductive heating arrangement by the DC power supply. The measurement device is configured to determine an electrical conductance value of the inductive heating arrangement from the ratio of the determined DC current to the determined DC voltage.

Preferably, the testing equipment simulates real use of an aerosol-generating article in a real electronic heating device as close as possible. A specific inductive heating device for aerosol-forming substrates including a susceptor, in particular a solid aerosol-forming substrate including a susceptor is described in WO2015/177255. This document and its description of the set-up, operation and working principle of the electronic aerosol-generating device is herewith incorporated by reference. The control unit of the testing equipment preferably comprises a power source, power supply electronics and a cavity for receiving an article to be tested identical or substantially identical as in the device described in WO2015/177255 in order to perform a heating of the susceptor arrangement in the testing equipment as close to the heating of the susceptor arrangement being part of an article comprising the susceptor arrangement and used in the said real inductive heating device.

Therefore, preferably, the control module comprises power supply electronics configured to operate at high frequency, the power supply electronics comprising a DC/AC inverter connected to a DC power source, the DC/AC inverter including a Class-E power amplifier including a transistor switch and an LC load network configured to operate at low ohmic load.

The DC power source generally may comprise any suitable DC power source including in particular a power supply unit to be connected to the mains, one or more single-use batteries, rechargeable batteries, or any other suitable DC power source capable of providing the required DC supply voltage and the required DC supply amperage. In one embodiment, the DC supply voltage of the DC power source is in the range of about 2.5 Volts to about 4.5 Volts and the DC supply amperage is in the range of about 2.5 to about 5 Amperes (corresponding to a DC supply power in the range of about 6.25 Watts and about 22.5 Watts). The power supply electronics is configured to operate at high frequency. For the purpose of this application, the term “high frequency” is to be understood to denote a frequency ranging from about 1 Megahertz (MHz) to about Megahertz (MHZ) (including the range of 1 MHz to 30 MHZ), in particular from about 1 Megahertz (MHz) to about 10 MHZ (including the range of 1 MHz to 10 MHZ), and even more particularly from about 5 Megahertz (MHz) to about 7 Megahertz (MHz) (including the range of 5 MHz to 7 MHz).

The power supply electronics comprises a DC/AC inverter connected to the DC power source. The DC/AC inverter includes a Class-E power amplifier including a transistor switch, a transistor switch driver circuit, and an LC load network. Class-E power amplifiers are generally known and are described in detail, for example, in the article “Class-E RF Power Amplifiers”, Nathan O. Sokal, published in the bimonthly magazine QEX, edition January/February 2001, pages 9-20, of the American Radio Relay League (ARRL), Newington, CT, U.S.A., Class-E power amplifiers are advantageous as regards operation at high frequencies while at the same time having a simple circuit structure comprising a minimum number of components (e.g. only one transistor switch needed, which is advantageous over Class-D power amplifiers which comprise two transistor switches that must be controlled at high frequency in a manner so as to make sure that one of the two transistors has been switched off at the time the other of the two transistors is switched on). In addition, Class-E power amplifiers are known for minimum power dissipation in the switching transistor during the switching transitions.

Preferably, the Class-E power amplifier is a single-ended first order Class-E power amplifier having a single transistor switch only.

The transistor switch of the Class-E power amplifier can be any type of transistor and may be embodied as a bipolar-junction transistor (BJT). More preferably, however, the transistor switch is embodied as a field effect transistor (FET) such as a metal-oxide-semiconductor field effect transistor (MOSFET) or a metal-semiconductor field effect transistor (MESFET).

The LC load network of the Class-E power amplifier of the induction heating device according to the invention is configured to operate at low ohmic load. The term “low ohmic load” is to be understood to denote an ohmic load smaller than about 2 Ohms.

Preferably, in the testing equipment, the LC load network comprises a shunt capacitor and a series connection of a capacitor and an inductor having an ohmic resistance. This ohmic resistance of the inductor is typically a few tenths of an Ohm. In operation, the ohmic resistance of the susceptor adds to the ohmic resistance of the inductor and should be higher than the ohmic resistance of the inductor, since the supplied electrical power should be converted to heat in the susceptor to an as high extent as possible in order to increase efficiency of the power amplifier and to allow transfer of as much heat as possible from the susceptor to the rest of the aerosol-forming substrate to effectively produce the aerosol. When a susceptor arrangement as such is to be tested, then the inductive heating arrangement is configured to generate an alternating magnetic field within parts of the holder for inductively heating a susceptor arrangement in the holder, when the holder is arranged within reach of the inductive heating arrangement.

The control module also comprises a receiving slot for receiving at least parts of the holder, wherein the slot is arranged such that upon accommodation of the parts of the holder in the receiving slot, the inductor of the LC load network is inductively coupled to the susceptor arrangement in the holder during testing.

In some embodiments, the holder comprises a cavity for receiving and accommodating a susceptor arrangement in the cavity. The cavity has a shape and size to accommodate the susceptor arrangement. Preferably, the cavity has the shape of a slit for receiving and accommodating an elongate flat susceptor arrangement, for example a strip-shaped susceptor arrangement.

At least one clip may be arranged in the cavity for fixing a susceptor arrangement in the cavity. Preferably, the holder comprises two clips oppositely arranged in the cavity for fixing a susceptor arrangement at both ends of the susceptor arrangement. Clips are very simple and effective fixing means. Clips allow, for example, to keep the susceptor arrangement in position during testing, in particular during heating up and cooling of the susceptor arrangement. Clips also have the advantage that a susceptor arrangement may be held without further physical contact of the susceptor arrangement with the holder, for example with cavity walls. This may not only be preferable to improve a testing efficiency in terms of time and power feed but also heat transmission to the susceptor is maximized and heat dissipation minimized. In addition, minimal physical contact of the susceptor arrangement with parts of the holder may prevent burning or smouldering of a holder housing. For manufacturing reasons, holder housings are manufactured of plastics material, while temperatures of a susceptor arrangement during the test may reach up to for example 400 degree Celsius.

To further reduce the risk of excessively heating up a holder housing, walls defining the cavity may be coated with a high temperature resistant coating, preferably a ceramic coating. Such high temperature resistant coatings typically have a thermal conductivity of less than 1 W/mk (Watt per meter times Kelvin), preferably less than 0.05 W/mK.

In order to simulate the thermal load of an aerosol-forming substrate, in particular a tobacco substrate, a susceptor arrangement is usually inserted when used in an electronic heating device, the cavity may comprise a heat resistant fibre material having a thermal conductivity higher than a thermal conductivity of air. The cavity may comprise a heat resistant felt material having a thermal conductivity higher than a thermal conductivity of air, such as for example heat resistant Kevlar felt. Such a heat resistant fibre material affects the temperature distribution over a surface of a susceptor arrangement.

In some embodiments, the testing equipment is adapted to test articles comprising the susceptor arrangement. In these embodiments the holder comprises holding means for holding a rod-shaped article comprising the susceptor arrangement. Such holding means are adapted to hold, preferably clamp, the rod-shaped article. Such holding means may, for example, be one or more pins, clamps in the form of half shells, a cavity the article is pushed into, arranged in or similar.

The testing equipment may further comprise a cooling device for cooling a susceptor arrangement, preferably at least in between heating cycles. Preferably, the cooling device may maintain the testing equipment at a predefined temperature. The cooling device may prevent overheating of the holder or of the susceptor arrangement. In order to repeat a test or in order to run a next test, the testing equipment has to cool down. With actively cooling of the testing equipment, in particular of the control unit, multiple tests may be performed with no or only little time interruption before a next test is run.

The testing equipment may comprise a support, wherein the holder module and the control module are mounted to the support. Preferably, the holder module and the control module are relatively movable against each other on the support, such that at least parts of the holder in the holder module are accommodatable in and releasable from a respective receiving slot in the control module. By this, a susceptor arrangement held in the holder may be arranged in the receiving slot in the control module for being tested.

Preferably, the holder module is linearly movable along guides versus and away from the control module. Preferably, the control module is fixedly arranged on the support and the holder module is moveably arranged on the support in order to be movable to and away from the control module.

Advantageously, a testing equipment is calibrated before testing a susceptor arrangement. To perform such a calibration test, the testing equipment may comprise a calibration susceptor for running a test cycle for determining a calibration factor for the testing equipment. To perform such a calibration test cycle, the calibration susceptor has fix susceptor values, for example fix permeability values, fix electrical resistance values or fix electrical conductance values, throughout a test cycle. By this, a result Y of a test run with the calibration susceptor can then be corrected by the known physical characteristics, such as known permeability values, known electrical resistance values or known electrical conductance values X of the calibration susceptor, wherein the error corresponds to Y-X. Preferably, the calibration susceptor has fix electrical conductance values.

According to the invention there is also provided a method for testing a susceptor arrangement in a testing equipment in simulated heating conditions of a heated susceptor arrangement in an aerosol-generating device during a user experience. The method comprises providing a susceptor arrangement comprising at least a first susceptor material and a second susceptor material;
a) bringing the susceptor arrangement into operational communication with an inductive heating arrangement, and inductively heating the susceptor arrangement with the inductive heating arrangement;
b) determining values associated to physical characteristics of the susceptor arrangement from measurements related to a load applied to a control circuit, the measurements being responsive to the susceptor arrangement in operational communication with the inductive heating arrangement during a test cycle;
repeating steps a) and b); thereby determining values associated to physical characteristics of the susceptor arrangement for subsequent test cycles;
comparing determined values associated to physical characteristics of the tested susceptor arrangement with predetermined susceptor values, preferably of a predefined susceptor arrangement in a predefined user experience;
accepting or rejecting the tested susceptor arrangement, if a difference between determined and predetermined susceptor values exceeds a predefined threshold.

Preferably, the method comprises measuring current and voltage drawn by the control circuit during a text cycle, and determining values associated to physical characteristics of the susceptor arrangement from the measured current and voltage.

In some embodiments, accepting or rejecting the tested susceptor arrangement is indicative of accepting or rejecting an entire susceptor arrangement batch, the tested susceptor arrangement has been taken from. By this, the testing of one or several susceptor arrangements, taken from, for example cut from, a same bobbin comprising a continuous band of susceptor is indicative of the quality of the entire batch. Should the tested susceptor arrangement or susceptor arrangements fail the test, the entire batch is rejected. This is advantageous as no articles are produced with the faulty susceptor material. Time and material cost may be saved and waste may be reduced.

The present method and testing equipment present a reliable and fast way to check the quality of a batch of susceptor material, without having to investigate the exact material properties of the susceptor arrangement, which would be extremely complex.

In some embodiments, the method comprises comparing determined values associated to physical characteristics of the susceptor arrangement per each test cycle with the predetermined susceptor values. In some other embodiments, the method comprises averaging determined values associated to physical characteristics of the susceptor arrangement over at least two, thus over several or over all test cycles and comparing said averaged susceptor values with the predetermined susceptor values.

In preferred embodiments, the method comprises comparing determined values associated to physical characteristics of the susceptor arrangement of subsequent test cycles; and rejecting the susceptor arrangement if a difference between determined values of subsequent test cycles exceed a predefined threshold.

Preferably, the determined values associated to physical characteristics of the susceptor arrangement correspond to determined apparent electrical conductance values, and predetermined susceptor values correspond to predetermined electrical conductance values.

Typically, a test cycle comprises a heating period and a cooling period.

The method may comprise actively cooling the susceptor arrangement in between heating periods. The cooling may be performed via cooling media to the control module or directly to the susceptor arrangement.

When the susceptor assembly is heated its apparent resistance increases. This increase in resistance can be observed and detected, for example by monitoring the DC current drawn from a DC power source. At constant voltage, the DC current decreases as the temperature of the susceptor arrangement increases. A high frequency alternating magnetic field provided by the induction device induces eddy currents in close proximity to the surface of the susceptor arrangement, an effect that is known as the skin effect. The resistance in the susceptor arrangement depends in part on the electrical resistances of the first and second susceptor materials and in part on the depth of the skin layer in each material available for induced eddy currents. When the second susceptor material reaches its Curie temperature it loses its magnetic properties. This causes an increase in the skin layer available for eddy currents in the second susceptor material, which causes a decrease in the apparent resistance of the susceptor. The result is a temporary increase in the detected DC current when the second susceptor material reaches its Curie temperature. This may be seen as a valley (local minimum) in a measured or determined resistance curve. The current continues to increase until the maximum skin depth is reached, which is at the point where the second susceptor material reaches its Curie temperature.

By remote detection of the change in resistance in the susceptor assembly, the moment at which the susceptor assembly reaches the second Curie temperature can be determined. This point may be seen as a hill (local maximum) in a measured or determined resistance curve.

In a real device, at this point, the electronics in the real device typically operates to vary the power supplied and thereby reduce or stop the heating of the susceptor assembly. The temperature of the susceptor assembly then decreases to below the Curie temperature of the second susceptor material. The power supply may be increased again, or resumed, either after a period of time or after it has been detected that the second susceptor material has cooled below its Curie temperature. By use of such a feedback loop the temperature of the susceptor assembly may be maintain to be approximately that of the second Curie temperature.

This behaviour in the physical characteristics, in particular of electrical resistance or electrical conductance, of the susceptor assembly, is very specific for a specific susceptor assembly having specific susceptor material combinations. A comparison of test results with such optimized heating characteristics of the susceptor assembly gives reliable information on an acceptable or defective susceptor arrangement. Thus, reliable information is achievable by the testing equipment if a tested susceptor arrangement fulfils testing parameters. By this, it may be determined that the susceptor arrangement or the entire batch the susceptor arrangement had been part of as a sample, is suitable to either be used as a heating element in an aerosol-generating article or that the series of articles comprising a susceptor arrangement from said batch are fulfilling quality requirements.

In some embodiments of the method, predetermined values associated to physical characteristics of the susceptor arrangement comprise a maximum and a minimum in electrical conductance per test cycle at predefined times during a test cycle, in particular during a heating period of the test cycle.

These maximum and minimum in electrical conductance are specific for a specific susceptor arrangement as these values are correlated to the process where a susceptor material in the susceptor arrangement is reaching its Curie temperature and losing its magnetic properties (temporary increase in detected current; decrease in resistance or increase in conductance; local minimum in resistance or local maximum in conductance), as well as to the point when a Curie temperature of the susceptor material has been reached (current increase up to said point, susceptor material has lost its spontaneous magnetic properties and has undergone a phase change from a ferro-magnetic or ferri-magnetic state to a paramagnetic state; local maximum of resistance or local minimum of conductance).

Preferably, the method comprises measuring a DC current drawn by the inductive heating arrangement from a DC power supply, measuring a DC voltage supplied to the inductive heating arrangement by the DC power supply, and determining electrical conductance values of the inductive heating arrangement from the ratio of the determined DC current to the determined DC voltage.

In preferred embodiments, the method may comprise operating power supply electronics of the testing equipment at high frequency, the power supply electronics comprising a DC/AC inverter connected to a DC power source, the DC/AC inverter including a Class-E power amplifier including a transistor switch and an LC load network configured to operate at low ohmic load.

The LC load network may comprise a shunt capacitor and a series connection of a capacitor and an inductor having an ohmic resistance. The method may comprise accommodating the susceptor arrangement in a receiving slot of a control module comprising the inductive heating arrangement, such that the inductor of the LC load network is inductively coupled to the susceptor arrangement during testing.

Preferably, the susceptor arrangement is an elongate susceptor arrangement, preferably in the form of a strip. Most preferably, the susceptor arrangement is an elongate multi-layer susceptor arrangement.

The elongate susceptor arrangement may have a thickness in a range of 0.03 millimeter to 0.15 millimeter, more preferably 0.05 millimeter to 0.09 millimeter. The elongate susceptor arrangement may have a width in a range of 2 millimeter to 6 millimeter, in particular 4 millimeter to 5 millimeter. Likewise, the elongate susceptor arrangement may have length in range of 8 millimeter to 19 millimeter, in particular 10 millimeter to 14 millimeter, preferably 10 to 12 millimeter.

Alternatively, the susceptor arrangement may be a susceptor rod or a susceptor pin or a multi-layer susceptor sleeve or a susceptor cup or a cylindrical susceptor arrangement.

The first susceptor material is preferably selected for maximum heating efficiency. Inductive heating of a magnetic susceptor material located in a fluctuating magnetic field occurs by a combination of resistive heating due to eddy currents induced in the susceptor, and heat generated by magnetic hysteresis losses. Preferably, the first susceptor material of the susceptor arrangement and the second susceptor material of the susceptor arrangement are in intimate physical contact with each other, wherein the second susceptor material comprises a Curie temperature of below 500 degree Celsius.

Preferably, the first susceptor material comprises no Curie temperature or comprises a Curie temperature above 500 degree Celsius.

The first susceptor material is preferably used primarily to heat the susceptor when the susceptor is placed in a fluctuating magnetic field. Any suitable material may be used. For example, the first susceptor material may be aluminium, or may be a ferrous material such as stainless steel. Preferably, first susceptor material comprises or consists of a metal, for example ferritic iron or stainless steel, in particular a grade 410, grade 420 or grade 430 stainless steel.

The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor assembly during operation. Thus, the Curie temperature of the second susceptor material should be below the ignition point of the aerosol-forming substrate. The immediate proximity of the first and second susceptor materials may be of advantage in providing an accurate temperature control.

The first susceptor material is preferably a magnetic material having a Curie temperature that Is above 500 degree Celsius. It is desirable from the point of view of heating efficiency that the Curie temperature of the first susceptor is above any maximum temperature that the susceptor assembly should be capable to be heated to. The Curie temperature of the second susceptor material may preferably be selected to be lower than 400 degree Celsius, preferably lower than 380 degree Celsius, or lower than 360 degree Celsius. It is preferable that the second susceptor material is a magnetic material selected to have a Curie temperature that is substantially the same as a desired maximum heating temperature. The Curie temperature of the second susceptor material may, for example, be in a range between 200 degree Celsius and 400 degree Celsius, or between 250 degree Celsius and 360 degree Celsius.

Thus, when heated, the first and second susceptor materials have the same temperature. The first susceptor material, which may be optimized for the heating of an aerosol-forming substrate when the susceptor arrangement is accommodated in an article, may have a first Curie temperature, which is higher than any predefined maximum heating temperature. Once the susceptor has reached the second Curie temperature, the magnetic properties of the second susceptor material change. At the second Curie temperature the second susceptor material reversibly changes from a ferromagnetic phase to a paramagnetic phase. During the inductive heating this phase-change of the second susceptor material may be detected without physical contact with the second susceptor material. Detection of the phase change may allow control over the heating of the aerosol-forming substrate in real use of the susceptor arrangement. For example, on detection of the phase change associated with the second Curie temperature the inductive heating may be stopped automatically. Thus, an overheating of the aerosol-forming substrate may be avoided, even though the first susceptor material, which is primarily responsible for the heating of the aerosol-forming substrate, has no Curie temperature or a first Curie-temperature which is higher than the maximum desirable heating temperature. After the inductive heating has been stopped the susceptor cools down until it reaches a temperature lower than the second Curie temperature. At this point the second susceptor material regains its ferromagnetic properties again. This phase-change may be detected without contact with the second susceptor material and the inductive heating may then be activated again. Thus, the inductive heating of the susceptor arrangement and thus of an aerosol-forming substrate surrounding the susceptor assembly, may be controlled by a repeated activation and deactivation of the inductive heating device. This temperature control is accomplished by contactless means. In the testing equipment, such temperature or power limits are generally not used as constraints to the testing as there is no risk of negative effect by overheating of a substrate.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding. It is preferred that the second susceptor material is present as a dense layer. A dense layer has a higher magnetic permeability than a porous layer, making it easier to detect fine changes at the Curie temperature. If the first susceptor material is optimised for heating of the substrate it may be preferred that there is no greater volume of the second susceptor material than is required to provide a detectable second Curie point.

Suitable material for the second susceptor material may include nickel and certain nickel alloys.

It has been found that a specific material selection of the second susceptor material may reduce undesired effects in the susceptor arrangement occurring during its production due to the impact of the restricted free movement between the various susceptor materials, in particular between various layers, on the magnetostriction, which is difficult to control during the mass production of such susceptor arrangements. In particular, these undesired effects may vary across different locations of the precursor laminate material which a plurality of susceptor arrangements are finally made of. As a result, the magnetic properties may vary between different susceptor arrangements even though being made of the same precursor material.

Therefore, preferably, the second susceptor material comprises or consists of a Ni—Fe-alloy comprising 75 weight percent to 85 weight percent and 10 weight percent to 25 weight percent Fe. More particular, the Ni—Fe-alloy may comprise 79 weight percent to 82 weight percent Ni and 13 weight percent to 15 weight percent Fe. It has been found that Ni—Fe-alloys including Ni and Fe in the above ranges exhibit only weak or even no magnetostriction. As a consequence, the second susceptor material of the second layer experiences no or only at least a reduced modification of its magnetic properties after its processing and throughout its temperature range of operation. This in turn allows for a mass production of multi-layer susceptor arrangements having a second magnetic layer with no or only little variation of its magnetic properties after processing and during subsequent operation.

As used herein, the term “weight percent” or also “percentage by weight” denotes the mass fraction of an element within the alloy which is the ratio of the mass of that respective element to the total mass of a sample of that alloy.

In addition to the main components, the remainder of the Ni—Fe-alloy may comprise one or more of the following elements: Co, Cr, Cu, Mn, Mo, Nb, Si, Ti and V.

As used herein, the symbol Ni stands for the chemical element nickel, the symbol Fe stands for the chemical element iron, the symbol Co stands for the chemical element cobalt, the symbol Cr stands for the chemical element chromium, the symbol Cu stands for the chemical element copper, the symbol Mn stands for the chemical element manganese, the symbol Mo stands for the chemical element molybdenum, the symbol Nb stands for the chemical element niobium, the symbol Si stands for the chemical element silicon, the symbol Ti stands for the chemical element titanium, and the symbol V stands for the chemical element vanadium.

The first susceptor material may be a first susceptor layer and may have a first layer thickness in range between 20 micrometer and 60 micrometer, in particular between 30 micrometer and 50 micrometer, preferably 40 micrometer.

The second susceptor material may be a second susceptor layer and may have a second layer thickness in range between 4 micrometer and 20 micrometer, in particular between 8 micrometer and 16 micrometer, preferably between 10 micrometer and 15 micrometer.

The second material may be intimately coupled to the first material. As used herein, the term “intimately coupled” refers to a mechanical coupling between two susceptor material, in particular susceptor layers, within the susceptor arrangement such that a mechanical force may be transmitted between the two materials, in particular in a direction parallel to a layer structure. The coupling may be a laminar, two-dimensional, areal or full-area coupling, that is, a coupling across the respective opposing surfaces of two layers. The coupling may be direct. In particular, the two material, which are intimately coupled with each other, may be in direct contact with each other. Alternatively, the coupling may be indirect. In particular, the two materials may be indirectly coupled via at least one intermediate material. Preferably, the second layer is arranged upon and intimately coupled to, in particular directly connected with the first layer.

The susceptor arrangement may further comprise a third susceptor material. The third susceptor material may be intimately coupled to the second susceptor material. In this context, the term “intimately coupled” is used in the same way as defined above with regard to the first and second material.

Preferably, the third susceptor material is a protective material configured to at least one of: to avoid aerosol-forming substrate sticking to the surface of the susceptor arrangement, to avoid material diffusion, for example metal migration, from the susceptor materials into the aerosol-forming substrate, to avoid or reduce thermal bending due to differences in thermal dilatation between the materials of the susceptor arrangement, or to protect other materials, in particular the second material from any corrosive influences.

The latter is particularly important, where the susceptor arrangement is embedded in an aerosol-forming substrate of an aerosol-generating article, that is, where the susceptor arrangement is in direct physical contact with aerosol-forming substrate. For this, the third susceptor material preferably comprises or consists of an anti-corrosive material. Advantageously, the anti-corrosive material improves the aging characteristics of those portions of the outer surface of the non-corrosion resistant second susceptor material which are covered by the third susceptor material and thus not directly exposed to the environment.

As used herein, the term “third layer” refers to a layer in addition to the first and second layer that is different from the first and second layer. In particular, any possible oxide layer on a surface of the first or second layer resulting from oxidation of the first or second susceptor material is not to be considered a third layer, in particular not a third layer comprising or consisting of an anti-corrosive material.

The third susceptor material or third layer may comprise or consist of a material identical to the first susceptor material of the first layer. Due to this, a multi-layer susceptor arrangement comprises at least two layers having the same coefficient of thermal expansion which results in reduced deformations of the susceptor arrangement through the temperature range of operation. This applies in particular where the susceptor arrangement only comprises the first, second and third layer and where the second layer is symmetrically sandwiched between the first and third layer.

Accordingly, the third susceptor material may comprise a metal, for example ferritic iron, or stainless steel, for example ferritic stainless steel, in particular a 400 series stainless steel such as grade 410 stainless steel, or grade 420 stainless steel, or grade 430 stainless steel, or stainless steel of similar grades. Alternatively, the third susceptor material may comprise or be a suitable non-magnetic, in particular paramagnetic, conductive material, such as aluminum (Al). Likewise, the third material may comprise or be a non-conductive ferrimagnetic material, such as a non-conductive ferrimagnetic ceramic.

It is also possible that the third material comprises or consists of an austenitic stainless steel. Advantageously, due to its paramagnetic characteristics and high electrical resistance, austenitic stainless steel only weakly shields the second layer from the magnetic field to be applied to the first and second susceptor material. As an example, the third layer may comprise or consist of X5CrNi18-10 (according to EN (European Standards) nomenclature, material number 1.4301, also known as V2A steel) or X2CrNiMo17-12-2 (according to EN (European Standards) nomenclature, material number 1.4571 or 1.4404, also known as V4A steel). In particular, the third layer may comprise or consist of one of 301 stainless steel, 304 stainless steel, 304L stainless steel, 316 stainless steel or 316L stainless steel (nomenclature according to SAE steel grades [Society of Automotive Engineers]).

The third material—if present—may be a third susceptor layer having a third layer thickness in range between 2 micrometer and 6 micrometer, in particular between 3 micrometer and 5 micrometer, preferably between 3 micrometer and 4 micrometer.

The layer thickness of the third layer may be in a range of 0.05 to 1.5, in particular 0.1 to 1.25, or 0.95 to 1.05, in particular 1 times a layer thickness of the first layer.

In case of a symmetric or close-to-symmetric layer configuration, the first layer as well as the third layer may have a thickness in range between 2 micrometer and 20 micrometer, in particular between 3 micrometer and 10 micrometer, preferably 3 to 6 micrometer.

The second layer may then have a thickness in range between 5 and 50 micrometer, in particular between 10 and 40 micrometer, preferably 20 to 40 micrometer.

In general, the susceptor arrangement described herein may be used to realize different geometrical configurations of the susceptor arrangement.

The method may further comprise fixing the susceptor arrangement for testing, preferably, in a cavity of a holder. Preferably, the method comprises clamping the susceptor arrangement, preferably in the cavity, wherein the susceptor arrangement preferably does not contact cavity walls except for clips used for clamping. By this, heat loss due to heat dissipation to the surrounding material may be prevented or reduced.

To further reduce heat conduction or dissipation, the susceptor arrangement may be thermally insulated by providing a high temperature resistant material surrounding the susceptor assembly. Preferably, such a high temperature resistant material is used to cover cavity walls the susceptor arrangement is accommodated in during testing.

In addition, or alternatively, it may be advantageous to envelop the susceptor arrangement with a heat resistant fibre material. Thereby, a real environment of the susceptor arrangement in an aerosol-forming substrate, for example a tobacco material containing aerosol-forming substrate is simulated. The heat resistant fibre material may be one as described above with respect to the testing equipment.

The method may further comprise calibrating the testing equipment and therein performing test cycles using a calibration susceptor having fix susceptor values throughout the test cycle, and determining a calibration factor for the testing equipment by comparison of calibration susceptor values of the calibration susceptor measured by the test equipment and of the fix susceptor values of the calibration susceptor.

Preferably, fix susceptor values are fix electrical conductance values and calibration susceptor values are calibration electrical conductance values.

In such a calibration cycle, the calibration susceptor simulates a load. This may, for example, be done by a calibration susceptor comprising a bobbin that is brought in operational connection with the inductive heating arrangement. Preferably, the bobbin is brought into operational connection with an induction coil of the inductive heating arrangement.

Advantages and features of the invention described either with respect to the testing equipment or with the testing method are applicable vice versa.

In some embodiments of the invention, the testing equipment and method for testing are adapted to enhance the velocity for testing rod-shaped articles comprising a susceptor arrangement. Preferably, in these embodiments, a serial, in particular continuous testing of rod-shaped articles comprising a susceptor arrangement is available. The control module and in particular an inductive heating arrangement in the control module is constructed in an open manner such that an article to be tested may be inserted into the control module for testing and being passed through the control module after testing. For example, the control module may comprise a receiving slot extending through the control module or may comprise a through-hole for the article to pass through the through hole. By this an article may be inserted and removed from a control module in a linear movement and in a same direction. This may enhance the velocity in providing new articles to be tested to a control module. It also allows the automatize or semi-automatize the article provision to the control module by simply pushing out tested articled from the control module. Tor example, this may be done by a subsequent article to be tested that is inserted into the receiving slot and thereby pushes the tested article out of the receiving slot and out of the control module. Therefore, in preferred embodiments of the testing equipment, the control module comprises a receiving slot forming a passage through the control module.

Also the holder module may comprise a passage for receiving a rod-shaped article in the passage. Thereby, an article may be provided to the holder module from one side of the holder module and the holder module may supply the article to the control module from an opposite side of the holder module. By this, provision of a rod-shaped article to be tested, supply of the article to a control module as well as the removal of the tested articles from a control module may be performed in a same linear direction. For supply of the article from the holder module to the control module, preferably the passage of the holder module and the receiving slot of the control module are linearly alignable.

In preferred embodiment, the control module is arranged such that the receiving slot in the control module is arranged vertically, such that articles to be tested may be received and pass the control module in a vertical manner. Thus, the articles are provided from above and are guide to and through the testing equipment mainly by gravitational force.

In the testing equipment, two control modules may be arranged in series. The inductive heating arrangements, in particular the coils are arranged distanced from each other such that single-length articles as well as double-length articles may be tested. The positioning of the article for the testing as well as keeping the position of the article during a measurement is preferably kept within small limits. Thus, a variable positioning of articles having different lengths in one control unit and one coil may be improved by the provision of two coils.

Depending on the orientation of a single-length article and by this the position of the susceptor arrangement in the article, the single-length article may be tested in a first or in a second one of the two control modules. For the double-length article, the two susceptor arrangements in the articles are each tested by one of the measurement devices in the two control modules. These embodiments are particularly advantageous for the testing of articles having different length and being vertically supplied to and passing the testing equipment by gravitational force.

Several control modules may be arranged parallel to each other. One holder module may be assigned to the several control modules. Alternatively, one holder module may be assigned to each one of the several control modules. Combinations are possible, for example in that a holder module serves only some of the several control modules.

Accordingly, the method for testing may comprise the steps of inserting a rod-shaped article comprising a susceptor arrangement into a receiving slot in the control module, testing the susceptor arrangement in the rod-shaped article, and then removing the tested rod-shaped article at an opposite site of the control module by passing the rod-shaped article through the receiving slot. The method may comprise supplying the rod-shaped article comprising the susceptor assembly from one side of the holder module into and through the holder module.

Preferably, the method comprises, guiding the rod-shaped articles vertically through the receiving slot in the control module.

Preferably, the method comprises pushing a tested article out of the receiving slot of the control module by inserting a further rod-shaped article to be tested into the receiving slot of the control module.

The method may comprise providing two control modules arranged in series and testing a single-length article in either one of the two control modules and testing a double-length article in both of the two control modules.

The method may comprise the step of performing parallel testing of several rod-shaped articles comprising a susceptor arrangement in several control modules arranged in parallel.

The invention is defined in the claims. However, below there is provided a non-exhaustive list of non-limiting examples. Any one or more of the features of these examples may be combined with any one or more features of another example, embodiment, or aspect described herein.

Example Ex1: A testing equipment for testing a susceptor arrangement in simulated heating conditions of a heated susceptor arrangement arranged in an aerosol-generating device during a user experience, the testing equipment comprising:
a holder module comprising a holder for receiving a susceptor arrangement to be tested;
a control module comprising an inductive heating arrangement and a measurement device comprising a control circuit; wherein the inductive heating arrangement is configured to generate an alternating magnetic field for inductively heating a susceptor arrangement;
wherein the measurement device is configured to determine values associated to physical characteristics of the susceptor arrangement from measurements related to a load applied to the control circuit responsive to a susceptor arrangement in operational communication with the inductive heating arrangement; and wherein the control circuit is configured to power the inductive heating arrangement for one test cycle or several subsequent test cycles of the susceptor arrangement and configured to determine if determined values associated to physical characteristics of the susceptor arrangement correspond to predetermined susceptor values.

Example Ex2: The testing equipment according to Example Ex1, wherein the measurement device is configured to determine values associated to physical characteristics of the susceptor arrangement from measurements of current and voltage drawn by the inductive heating device.

Example Ex3: The testing equipment according to any one of Examples Ex1 to Ex2, wherein the control module is configured to output acceptance of a tested susceptor assembly, if predetermined physical characteristics values are reached or to output rejection of a tested susceptor assembly, if predetermined physical characteristics values are not reached.

Example Ex4: The testing equipment according to any one of the preceding Examples, wherein the control module is configured to compare determined values associated to physical characteristics of the susceptor arrangement per each test cycle with the predetermined physical characteristics values.

Example Ex5: The testing equipment according to any one of the Examples Ex1 to Ex3, wherein the control module is configured to average determined values associated to physical characteristics of the susceptor arrangement over two, several or over all performed test cycles and comparing said averaged physical characteristics values with the predetermined physical characteristics values.

Example Ex6: The testing equipment according to any one of the preceding Examples, wherein values associated to physical characteristics of the susceptor arrangement are apparent electrical conductance values and the predetermined physical characteristics values are predetermined electrical conductance values.

Example Ex7: The testing equipment according to any one of the preceding Examples, wherein the measurement device comprises a current measurement device for determining a DC current drawn by the inductive heating arrangement from a DC power supply of the device, and a voltage measurement device for determining a DC voltage supplied to the inductive heating arrangement by the DC power supply, and wherein the measurement device is configured to determine an apparent electrical conductance value of the inductive heating arrangement from the ratio of the determined DC current to the determined DC voltage.

Example Ex8: The testing equipment according to any one of the preceding Examples, wherein the control module comprises power supply electronics configured to operate at high frequency, the power supply electronics comprising a DC/AC inverter connected to a DC power source, the DC/AC inverter including a Class-E power amplifier including a transistor switch and an LC load network configured to operate at low ohmic load.

Example Ex9: The testing equipment according to Example Ex8, wherein the LC load network comprises a shunt capacitor and a series connection of a capacitor and an inductor having an ohmic resistance, and wherein the control module comprises a receiving slot for receiving at least parts of the holder, wherein the slot is arranged such that upon accommodation of the parts of the holder in the receiving slot, the inductor of the LC load network is inductively coupled to the susceptor arrangement during testing.

Example Ex10: The testing equipment according to any one of the preceding Examples, wherein the holder comprises a cavity for receiving and accommodating a susceptor arrangement in the cavity.

Example Ex11: The testing equipment according to Example Ex10, wherein the cavity has the shape of a slit for receiving and accommodating an elongate flat susceptor arrangement.

Example Ex12: The testing equipment according to any one of Examples Ex10 to Ex11, wherein at least one clip is arranged in the cavity for fixing a susceptor arrangement in the cavity.

Example Ex13: The testing equipment according to Example Ex12, wherein the holder comprises two clips oppositely arranged in the cavity for fixing a susceptor arrangement at both ends of the susceptor arrangement.

Example Ex14: The testing equipment according to any one of Examples Ex10 to Ex13, wherein walls defining the cavity are coated with a high temperature resistant coating, preferably a ceramic coating.

Example Ex15: The testing equipment according to any one of Examples Ex10 to Ex14, wherein the cavity comprises a heat resistant fibre material having a thermal conductivity higher than a thermal conductivity of air, preferably comprises a heat resistant felt material having a thermal conductivity higher than a thermal conductivity of air, such as for example heat resistant Kevlar felt.

Example Ex16: The testing equipment according to any one of Examples Ex1 to Ex9, wherein the holder comprises holding means for holding a rod-shaped article comprising the susceptor arrangement.

Example Ex17: The testing equipment according to any one of the preceding Examples, further comprising a cooling device for cooling a susceptor arrangement in between heating cycles.

Example Ex18: The testing equipment according to any one of the preceding Examples, further comprising a support, wherein the holder module and the control module are mounted to the support, and wherein the holder module and the control module are relatively movable against each other on the support, such that at least parts of the holder in the holder module are accommodatable in and releasable from a respective receiving slot in the control module.

Example Ex19: The testing equipment according to Examples Ex18, wherein the holder module is linearly movable along guides versus and away from the control module.

Example Ex20: The testing equipment according to any one of Examples Ex18 to Ex19, wherein the control module is fixedly arranged on the support.

Example Ex21: The testing equipment according to any one of the preceding Examples, further comprising a calibration susceptor for running a test cycle for determining a calibration factor for the testing equipment, the calibration susceptor having fix physical characteristics, for example fix electrical conductance values throughout a test cycle.

Example Ex22: A method for testing a susceptor arrangement in a testing equipment in simulated heating conditions of a heated susceptor arrangement in an aerosol-generating device during a user experience, the method comprising:
providing a susceptor arrangement comprising at least a first susceptor material and a second susceptor material;
a) bringing the susceptor arrangement into operational communication with an inductive heating arrangement, and inductively heating the susceptor arrangement with the inductive heating arrangement;
b) determining values associated to physical characteristics of the susceptor arrangement from measurements related to a load applied to a control circuit, the measurements being responsive to the susceptor arrangement in operational communication with the inductive heating arrangement during a test cycle;
repeating steps a) and b); thereby determining values associated to physical characteristics of the susceptor arrangement for subsequent test cycles;
comparing determined values associated to physical characteristics of the tested susceptor arrangement with predetermined physical characteristics values of a predefined susceptor arrangement in a predetermined user experience;
accepting or rejecting the tested susceptor arrangement, if a difference between determined and predetermined physical characteristics values exceeds a predefined threshold.

Example Ex23: The method according to Example Ex22, therein measuring current and voltage drawn by the control circuit during a text cycle, and determining values associated to physical characteristics of the susceptor arrangement from the measured current and voltage.

Example Ex24: The method according to any one of Example Ex22 to Ex23, wherein accepting or rejecting the tested susceptor arrangement is indicative of accepting or rejecting an entire susceptor arrangement batch, the tested susceptor arrangement is part of.

Example Ex25: The method according to any one of Examples Ex22 to Ex24, therein comparing determined values associated to physical characteristics of the susceptor arrangement per each test cycle with the predetermined associated to physical characteristics values.

Example Ex26: The method according to any one of Examples Ex22 to Ex24, therein averaging determined values associated to physical characteristics of the susceptor arrangement over several or over all test cycles and comparing said averaged physical characteristics values with the predetermined physical characteristics values.

Example Ex27: The method according to any one of Examples Ex22 to Ex26, therein comparing determined values associated to physical characteristics of the susceptor arrangement of subsequent test cycles; and rejecting the susceptor arrangement if a difference between physical characteristics values of subsequent test cycles exceed a predefined threshold.

Example Ex28: The method according to any one of Examples Ex22 to Ex27, wherein the determined values associated to physical characteristics of the susceptor arrangement correspond to determined electrical conductance values, and predetermined physical characteristics values correspond to predetermined electrical conductance values.

Example Ex29: The method according to any one of Examples Ex22 to Ex28, wherein a test cycle comprises a heating period and a cooling period.

Example Ex30: The method according to Example Ex29, therein actively cooling the susceptor arrangement in between heating periods.

Example Ex31: The method according to any one of Examples Ex22 to Ex30, where predetermined values associated to physical characteristics of the susceptor arrangement comprise a maximum and a minimum in electrical conductance per test cycle at predefined times during a test cycle, preferably during a heating period of the test cycle.

Example Ex32: The method according to any one of Example Ex22 to Ex31, therein measuring a DC current drawn by the inductive heating arrangement from a DC power supply, and measuring a DC voltage supplied to the inductive heating arrangement by the DC power supply, and determining electrical conductance values of the inductive heating arrangement from the ratio of the determined DC current to the determined DC voltage.

Example Ex33: The method according to any one of Example Ex22 to Ex32, further comprising operating power supply electronics of the testing equipment at high frequency, the power supply electronics comprising a DC/AC inverter connected to a DC power source, the DC/AC inverter including a Class-E power amplifier including a transistor switch and an LC load network configured to operate at low ohmic load.

Example Ex34: The method according to Examples Ex33, wherein the LC load network comprises a shunt capacitor and a series connection of a capacitor and an inductor having an ohmic resistance, and accommodating the susceptor arrangement in a receiving slot of a control module comprising the inductive heating arrangement, such that the inductor of the LC load network is inductively coupled to the susceptor arrangement during testing.

Example Ex35: The method according to any one of Examples Ex22 to Ex34, wherein the susceptor arrangement is an elongate susceptor arrangement in the form of a strip.

Example Ex36: The method according to any one of Examples Ex22 to Ex35, wherein the first susceptor material of the susceptor arrangement and the second susceptor material of the susceptor arrangement are in intimate physical contact with each other, wherein the second susceptor material comprises a Curie temperature of below 500 degree Celsius.

Example Ex37: The method according to any one of Examples Ex22 to Ex36, wherein the first susceptor material comprises no Curie temperature or comprises a Curie temperature above 500 degree Celsius.

Example Ex38: The method according to any one of Examples Ex22 to Ex37, wherein the first susceptor material comprises or consists of a metal, for example ferritic iron or stainless steel, in particular a grade 410, grade 420 or grade 430 stainless steel.

Example Ex39: The method according to any one of Examples Ex22 to Ex38, wherein the second susceptor material comprises or consists of a Ni—Fe-alloy comprising 75 weight percent to 85 weight percent and 10 weight percent to 25 weight percent Fe.

Example Ex40: The method according to Example Ex39, wherein the Ni—Fe alloy further comprises one or more of the following elements: Co, Cr, Cu, Mn, Mo, Nb, Si, Ti and V.

Example Ex41: The method according to any one of Examples Ex38 to Ex40, wherein the Ni—Fe-alloy comprises 79 weight percent to 82 weight percent Ni and 13 weight percent to 15 weight percent Fe.

Example Ex42: The method according to any one of Examples Ex22 to Ex41, wherein the first susceptor material is a first layer having a layer thickness in a range between 20 micrometer and 60 micrometer.

Example Ex43: The method according to any one of Examples Ex22 to Ex42, wherein the second susceptor material is a second layer having a layer thickness in a range between 4 micrometer and 20 micrometer.

Example Ex44: The method according to any one of Examples Ex22 to Ex43, wherein the susceptor arrangement comprises a third susceptor material layer intimately coupled to the second susceptor material.

Example Ex45: The method according to Example Ex44, wherein the third susceptor material is at least partly identical to the first susceptor material.

Example Ex46: The method according to any one of Examples Ex44 to Ex45, wherein the third susceptor material comprises or consists of an austenitic stainless steel, in particular one of 301 stainless steel, 304 stainless steel, 316 stainless steel or 316L stainless steel.

Example Ex47: The method according to any one of Examples Ex44 to Ex46, wherein the third susceptor material is a third layer having a layer thickness in a range between 2 micrometer and 6 micrometer.

Example Ex48: The method according to any one of Examples Ex22 to Ex47, further comprising fixing the susceptor arrangement in a cavity of a holder for testing.

Example Ex49: The method according to Example Ex48, clamping the susceptor arrangement in the cavity, wherein the susceptor arrangement does not contact cavity walls except for clips used for clamping.

Example Ex50: The method according to any one of Examples Ex22 to Ex49, further comprising thermally insulating the susceptor arrangement by providing a high temperature resistant material surrounding the susceptor arrangement.

Example Ex51: The method according to any one of Examples Ex22 to Ex50, enveloping the susceptor arrangement with a heat resistant fibre material, thereby simulating a real environment of the susceptor arrangement in an aerosol-forming substrate, for example a tobacco material containing aerosol-forming substrate.

Example Ex52: The method according to any one of Examples Ex22 to Ex51, further comprising calibrating the testing equipment, therein performing test cycles using a calibration susceptor having fix physical characteristics values throughout the test cycle, and determining a calibration factor for the testing equipment by comparison of calibration physical characteristics values of the calibration susceptor measured by the test equipment and of the fix physical characteristics values of the calibration susceptor.

Example Ex53: The method according to Example Ex52, wherein the fix physical characteristics values are fix electrical conductance values and calibration physical characteristic values are calibration electrical conductance values.

Example Ex54: The method according to any one of Examples Ex52 to Ex53, wherein the calibration susceptor simulates a load and comprises a bobbin that is brought in operational connection with the inductive heating arrangement.

Example Ex55: The method according to Example Ex55, wherein the bobbin is brought into operational connection with an induction coil of the inductive heating arrangement.

Example Ex56: The testing equipment according to any one of Examples Ex1 to Ex8, wherein the control module comprises a receiving slot forming a passage through the control module.

Example Ex57: The testing equipment according to Example Ex56, wherein the receiving slot is a through hole through the control module.

Example Ex58: The testing equipment according to any one of Examples Ex56 to Ex 57, wherein the holder module comprises a passage for receiving a rod-shaped article in the passage. Example Ex59: The testing equipment according to Example Ex58, wherein the passage of the holder module and the receiving slot of the control module are linearly aligneable.

Example Ex60: The testing equipment according to any one of Examples Ex56 to Ex59, wherein the control module is arranged such that the receiving slot in the control module is arranged vertically, such that articles to be tested may be received and pass the control module in a vertical manner.

Example Ex61: The testing equipment according to any one of Examples Ex56 to Ex60, wherein two control modules are arranged in series.

Example Ex62: The testing equipment according to any one of Examples Ex56 to Ex 61, wherein several control modules are arranged parallel to each other.

Example Ex63: The testing equipment according to Example Ex62, wherein one holder module is assigned to the several control modules.

Example Ex64: The testing equipment according to Example Ex62, wherein a holder module is assigned to each one of the several control modules.

Example Ex65: The method according to any one of Examples Ex22 to Ex47, therein inserting a rod-shaped article comprising a susceptor arrangement into a receiving slot in the control module, testing the susceptor arrangement in the rod-shaped article, and then removing the tested rod-shaped article at an opposite site of the control module by passing the rod-shaped article through the receiving slot.

Example Ex66: The method according to Example Ex65, supplying the rod-shaped article comprising the susceptor assembly from one side of the holder module into and through the holder module.

Example Ex67: The method according to any one of Examples Ex65 to Ex66, guiding the rod-shaped articles vertically through the receiving slot in the control module.

Example Ex68: The method according to any one of Examples Ex65 to Ex67, thereby pushing a tested article out of the receiving slot of the control module by inserting a further rod-shaped article to be tested into the receiving slot of the control module.

Example Ex69: The method according to any one of Examples Ex65 to Ex68, therein providing two control modules arranged in series and testing a single-length article in either one of the two control modules and testing a double-length article in both of the two control modules. Example Ex70: The method according to any one of Examples Ex65 to Ex69, therein performing parallel testing of several rod-shaped articles comprising a susceptor arrangement in several control modules arranged in parallel.

### EXAMPLES WILL NOW BE FURTHER DESCRIBED WITH REFERENCE TO THE FIGURES IN WHICH

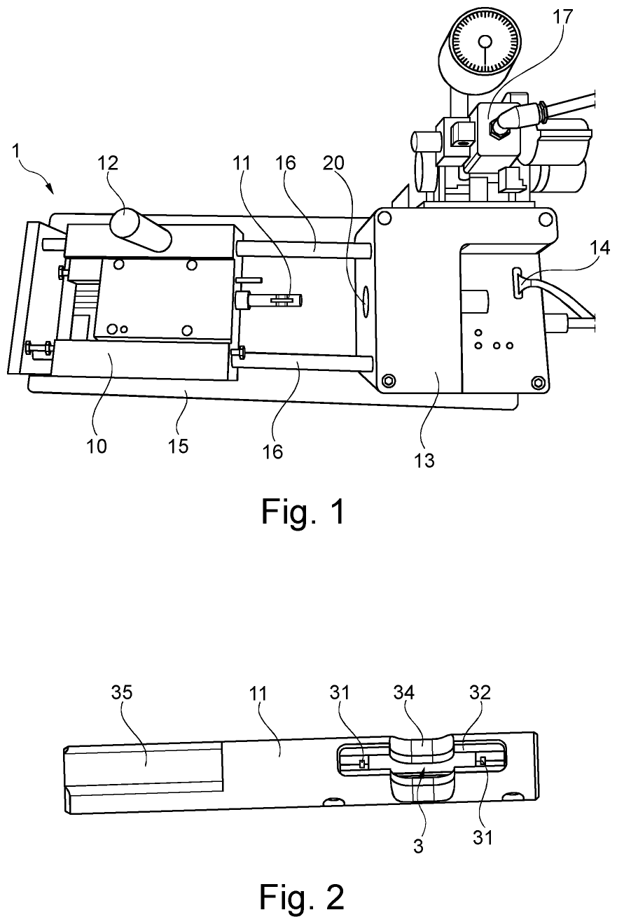

FIG. 1 illustrates a testing equipment;

FIG. 2 schematically illustrates a holder for an elongate flat susceptor arrangement;

FIG. 3 shows a view into a control module;

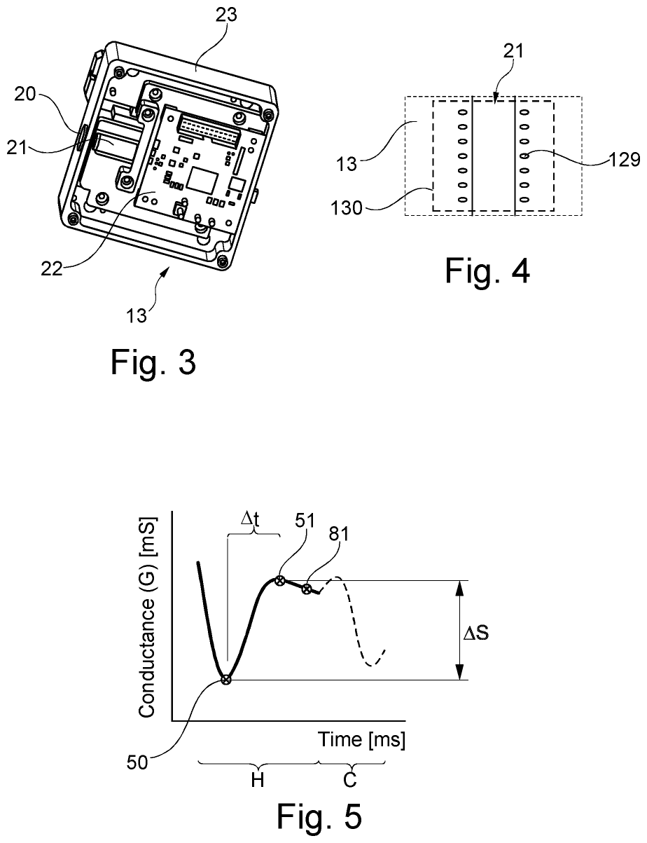

FIG. 4 schematically shows the excitation coil arrangement in the control module;

FIG. 5 is a graph illustrating a conductance curve of an embodiment of a susceptor arrangement during a test cycle;

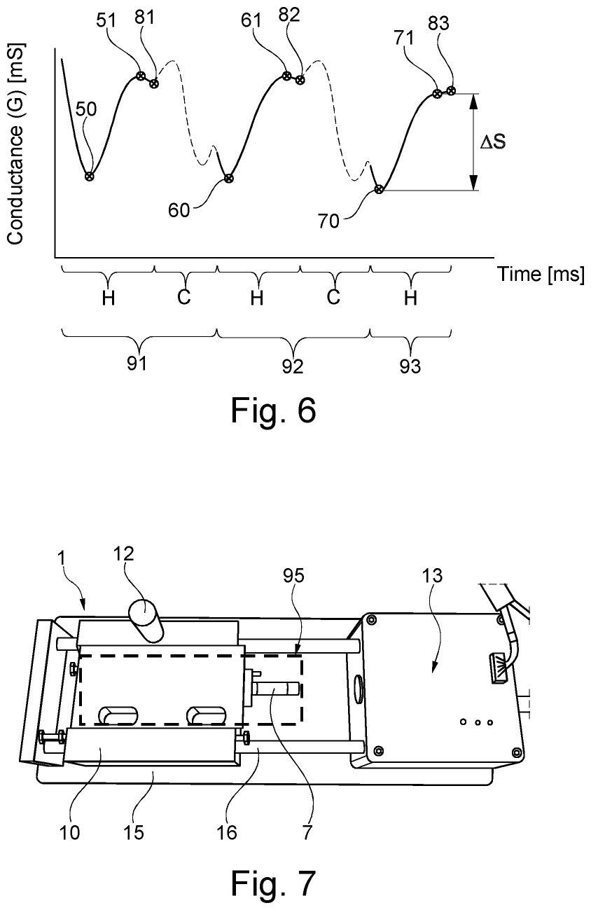

FIG. 6 shows conductance values determined during a sequence of text cycles;

FIG. 7 illustrates a testing equipment with calibration susceptor;

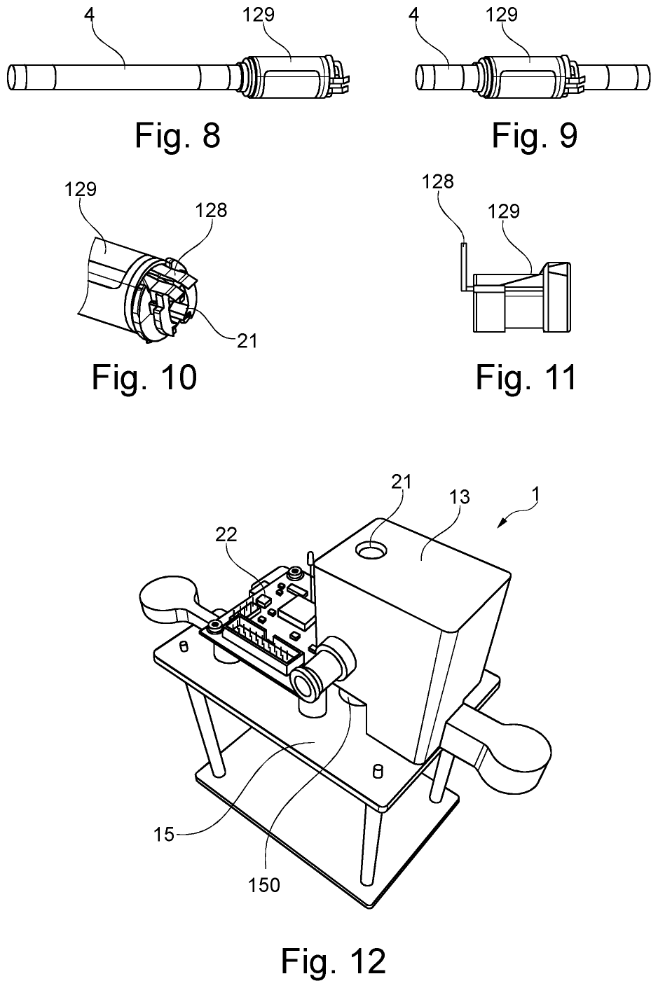

FIG. 8, 9 illustrate an open coil arrangement with before (FIG. 8) and after article insertion (FIG. 9);

FIG. 10,11 show the coil arrangement with electrical contacts in-line with a coils passage (FIG. 10) and bent for electrical contact (FIG. 11);

FIG. 12 shows a testing equipment with vertical passage;

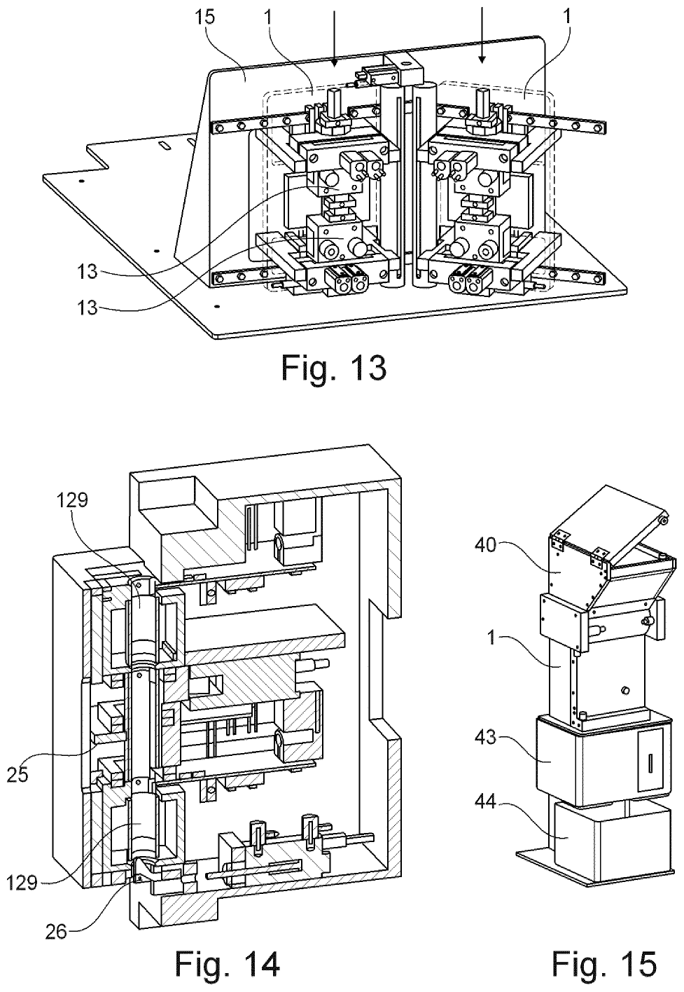

FIG. 13 shows a modular set-up of two testing equipment each comprising two serially arranged control modules;

FIG. 14 is an internal view of a testing equipment comprising two serially arranged control modules;

FIG. 15 illustrates a set-up of an apparatus with integrated testing equipment to be used during article manufacturing.

FIG. 1 illustrates a testing equipment 1 in an open position, thus ready to be provided with a susceptor arrangement to be tested.

The testing equipment 1 comprises a holder module 10 and a control module 13 arranged on a support 15.

The control module 13 is fixedly arranged on the support 15. The holder module 10 is movably arranged on the support 15. The holder module 10 comprises a user handle 12 by which the holder module 10 may be linearly moved versus the control module 13 along two rails 16 arranged in parallel along the support 15.

The holder module 10 comprises a holder 11 for holding a susceptor arrangement (not shown). The holder 11 may be an integral part of the holder module 10. The holder 11 is centrally arranged in a front side of the holder module 10 facing the control module 13.

Advantageously, after a susceptor arrangement is inserted into the holder 11, the holder module 10 is slid versus the control module 13 and the holder 11 is inserted into the control module 13 via opening 20 arranged in the side of the control module 13 facing the holder module 10.

The control module 13 internally comprises an excitation device and a measuring device (not shown) for performing one or preferably several subsequent test cycles, thus heating and cooling cycles of the susceptor arrangement. The movement of the holder module 10 into the control module 13 causes the insertion of the holder 11 and with it a susceptor arrangement in the holder to be accommodated in the internal excitation device of the control module 13 to run the test.

The excitation device includes the excitation coil which generates a varying magnetic field which penetrates the susceptor arrangement during the test and induces eddy currents for heat generation. The measuring device is configured to measure the induced load into the system which comprises the voltage and the current absorbed upstream the excitation device.

The testing device shown in FIG. 1 further comprises a cooling unit 17 for cooling the control module 13. Preferably, with the cooling unit 17, the testing equipment 1, in particular the control unit 13, may be maintained at a predefined temperature, for example below 100 degree Celsius.

This is advantageous as it allows to test samples with continuity as it avoids overheating, and multiple tests can be performed with little or no interruption. Without active cooling, more time is needed as it is necessary to wait until the equipment cools down before running a next test.

Data of the test is sent to a processor (not shown) through serial streaming cables 14 provided in the control unit 13. In the processor, data and test analysis may be performed.

FIG. 2, shows a holder 11 in more detail. The holder 11 comprises a cavity 3 in the form of a longitudinal slit 3 for insertion of an elongate susceptor arrangement (not shown) to be tested.

A clip 31 is arranged at each of the opposite longitudinal ends of the cavity 3. By the clips 31, the susceptor arrangement is kept in position in the cavity 3 during the test.

Direct physical contact of the susceptor arrangement to the holder 11 is brought to a minimum. With a cavity 3 in the form of a slit and clips 31 for holding the susceptor arrangement, the susceptor arrangement is almost suspended in air with almost no physical contact with the holder (apart from clips 31).

The cavity walls comprise a thermal insulation coating 32, for example a thermally insulating ceramic coating, along the longitudinal side walls of the cavity 3. With such a coating 32, the risk of burning the holder 11 may be reduced or avoided, in particular if a holder body is made of plastics.

The holder 11 comprises insertion means 35, here in the form of a flattened circumferential side of the otherwise rod-shaped holder. The insertion means 35 are arranged at the end of the holder 11 opposite the cavity 3. The flattened insertion means 35 allows for insertion of the holder 11 into the holder module 10 in one fixed rotation position only. In addition, the insertion means 35 guarantees that the holder 11 is fixed in its rotational position when arranged in the holder module 10 and thus stable during a test. Insertion means may allow to supply the holder 11 with a susceptor arrangement before the holder 11 is placed in the holder module 10.

In other embodiments, the testing equipment 1 may also be used with consumables. Thus, the testing equipment 1 may directly be used for testing an aerosol-generating article comprising the susceptor arrangement such as, for example, an inductively heatable tobacco rod comprising a strip-shaped multi-layer susceptor arrangement. In these embodiments the consumable to be tested mainly replaces the holder 11. Thus, the holder module 10 may be configured to comprise a tubular slot for directly receiving and accommodating the article. Alternatively, the holder may comprise holder means configured to receive such a heat stick.

FIG. 3 shows an internal view of the control module 13. The control housing 23 comprises an opening 20 and a cylindrical slot 21 for receiving the holder 11 comprising the susceptor arrangement. The control module 13 further comprises a PCB (Printed Circuited Board) 22. The PCB 22 comprises all the components normally included in a marketed device such as power supply, excitation device, measurement device etc. However, preferably, the testing equipment 1 does not comprise encumbrance constraints as the corresponding real device, such as, for example, power limitation, temperature limits etc. Accordingly, testing of a susceptor arrangement may be performed in very stable conditions with accordingly precise testing results.

Once the holder 11 has been inserted into the slot 21 of the control module 13, the configuration is such that the susceptor arrangement reaches a nominal position in the control module 13. To run the test, the testing equipment 1 starts producing multiple calibration pulses with the aim to measure characteristic points of a calibration curve of the susceptor arrangement, preferably in terms of conductance values of the susceptor arrangement.

In FIG. 4 is a schematic illustration of a control module 13 and the slot 21 in the control module 13. In order to check the quality of the susceptor arrangement, the part of the holder comprising the susceptor arrangement is accommodated in the slot 21.

Located in the control module 13 is an excitation coil 129, which longitudinally surrounds the slot 21, and which forms part of a LRC measuring circuit indicated with block 130.

The testing equipment 1 operates more or less identical to a coil module used in a marketed device. In the testing equipment 1 such a real device shall be simulated as close as possible such that the susceptor arrangement is heated as in the real device, thus in order to heat the aerosol-forming substrate of the article for aerosol formation.

In FIG. 5, a calibration curve in terms of conductance values (millisiemens) over time (millisecond) is illustrated. In FIG. 5, a typical output of a single susceptor test provided by the testing equipment 1 according to the present invention is shown. The calibration curve is shown along a hearing period H and a cooling period C of a test cycle.

A heating pulse is such that the susceptor conductance value reaches the valley 50 with a conductance value GV1 after a time tV1. After subsequent heating at time tH1 the hill 51 with conductance value GH1 is reached.

In the measurement device of the control module 12, the hill value 51 and the valley value 50 are detected and measured 50, and as a result ΔS (difference in conductance between hill 51 and valley 50, and the associated times tV1 and tH1 to reach the valley and the hill points and as a result Δt (time to get from valley to hill). Then the susceptor is cooled, which is indicated by the dashed line.

During the testing, the susceptor is let to reach the hill 51 and even going beyond as in this way also the shape of the hill can be detected and measured. This is illustrated in the graph by the curve from points 51 to 81 (corresponding to conductance values GH1 to GE1).

In the testing equipment, there is no risk of overheating a heat stick or tobacco plug, where in real conditions the susceptor arrangement is accommodated for heating a consumable.

When knowing that a valid calibration curve has been obtained in a test, this means that the susceptor arrangement is correctly manufactured, has satisfactory material quality and provides a satisfactory performance upon being heated.

The conductance curve in FIG. 5 and according valley and hill values in conductance basically illustrates the relationship between the DC current drawn from a power source in the testing equipment over time as the temperature of the susceptor arrangement increases.

The DC current drawn from the power source is measured at an input side of a DC/AC converter. It may be assumed that the voltage of the power source remains approximately constant. As the susceptor arrangement is inductively heated, the apparent resistance of the susceptor increases. This increase in resistance is observed as a decrease in the DC current drawn from the power source, which at constant voltage decreases as the temperature of the susceptor arrangement increases. The high frequency alternating magnetic field provided by the exitation device of the control module 13 induces eddy currents in close proximity to the susceptor surface (skin effect). The resistance in the susceptor arrangement depends in part on the electrical resistance of the first susceptor material, the resistance of the second susceptor material and in part on the depth of the skin layer in each material available for induced eddy currents, and the resistance is in turn temperature dependent. As the second susceptor material reaches its Curie temperature, it loses its magnetic properties. This causes an increase in the skin layer available for eddy currents in the second susceptor material, which causes a decrease in the apparent resistance of the susceptor arrangement. The result is a temporary increase in the detected DC current when the skin depth of the second susceptor material begins to increase, the resistance begins to fall. The current continues to increase until the maximum skin depth is reached, which coincides with the point where the second susceptor material has lost its spontaneous magnetic properties. This point is called the Curie temperature and is seen as the hill (the local maximum) 51 in FIG. 5. At this point the second susceptor material has undergone a phase change from a ferro-magnetic or ferri-magnetic state to a paramagnetic state. At this point, the susceptor arrangement is at a known temperature (the Curie temperature, which is an intrinsic material-specific temperature). If the control unit continues to generate an alternating magnetic field (i.e. power to the DC/AC converter is not interrupted) after the Curie temperature has been reached, the eddy currents generated in the susceptor arrangement will run against the resistance of the susceptor arrangement, whereby Joule heating in the susceptor arrangement will continue, and thereby the resistance will increase again and current will start falling again as long as the control unit 13 continues to provide power to the susceptor arrangement.

Therefore, the apparent resistance of the susceptor arrangement (and correspondingly the current IDC drawn from the power source) may vary with the temperature of the susceptor arrangement in a strictly monotonic relationship over certain ranges of temperature of the susceptor arrangement. The strictly monotonic relationship allows for an unambiguous determination of the temperature of the susceptor arrangement from a determination of the apparent resistance or apparent conductance (1/R). This is because each determined value of the apparent resistance is representative of only one single value of the temperature, so that there is no ambiguity in the relationship. The monotonic relationship of the temperature of the susceptor arrangement and the apparent resistance allows for the determination and control of the temperature of the susceptor arrangement and thus for the determination and control of the temperature also an aerosol-forming substrate the susceptor arrangement is intended to be arranged in for heating the substrate.

The apparent resistance of the susceptor arrangement can be remotely detected by monitoring at least the DC current drawn from the DC power source.

At least the DC current drawn from the power source is monitored by the control module 13. Preferably, both the DC current drawn from the power source and the DC supply voltage are monitored. The control module 13 regulates the supply of power provided to the inductive heating device based on a conductance value or a resistance value, where conductance is defined as the ratio of the DC current to the DC supply voltage and resistance is defined as the ratio of the DC supply voltage to the DC current.

The measurement device of the control module 13 may comprise a current sensor to measure the DC current. The measurement may optionally comprise a voltage sensor to measure the DC supply voltage. The current sensor and the voltage sensor are located at an input side of the DC/AC converter. The DC current and optionally the DC supply voltage are provided by feedback channels to a controller to control the further supply of AC power to the excitation device.

Preferably, the calibration of the susceptor arrangement is repeated multiple times so that the variability over time of the ΔS may be recorded as an additional output. FIG. 6 illustrates a typical output of a susceptor test provided by the testing equipment 1, for example as shown in FIG. 1, where a series of three test cycles 91,92,93 are performed.

A first heating pulse is such that the susceptor reaches the valley 50 with conductance value GV1 after a time tV1, and subsequently the hill 51 with conductance value GH1 after a time tH1. Then the susceptor is cooled (dashed line) until a second heating pulse is provided, such that the susceptor reaches the valley 60 with conductance value GV2 after a time tV2, and subsequently the hill 61 with conductance value GH2 after a time tH2. Then the susceptor is cooled again until a third heating pulse is provided, such that the susceptor reaches the valley 70 with conductance value GV3 after a time tV3, and subsequently the hill 71 with conductance value GH3 after a time tH3. This may be continued for a desired number of calibrations.

Also in the three test cycles 91,92,93, the susceptor is let to reach the hills 51,61,71 and le to go beyond. This is illustrated in the graph by the curves from points 51 to 81 (corresponding to conductance values GH1 to GE1), points 61 to 82 (corresponding to conductance values GH2 to GE2) and points 71 to 83 (corresponding to conductance values GH3 to GE3).

The equipment may monitor the values of subsequent ΔS and their evolution and mean value.

Outcomes of the measurement device may, for example, be in terms of number of calibrations and associated average ΔS obtained along with ΔS value at each calibration pulse.

According to such analysis a decision whether accepting or rejecting the sample may be taken. Preferably, the tests are run on a susceptor arrangement, which is a “sample”. This means that the sample represents an entire material batch, generally in the form of a susceptor bobbin. Thus, positive tests on the sample results in the acceptance of the entire batch. Accordingly, failure of the tests on the sample results in the rejection of the entire batch. This simplifies testing of an entire batch as it is known that within a batch there is in general very little variability in physical characteristics of the batch material.

FIG. 7 shows the testing equipment 1 used with a calibration susceptor 7 and indicated with a block 95 in FIG. 7. Calibration susceptor 7 is not a real susceptor but comprises a bobbin (not shown) which, when inserted into the slot 21 of the control module 13, behaves as a transformer unit. This is enabled by the two windings, where the internal winding is the one of the bobbin of the calibration susceptor 7 and the external winding is the excitation coil 11 of the control module 13. The calibration susceptor block 95 internally comprises an electric arrangement simulating a load.

As a result, when the bobbin of the calibration susceptor 7 is used to run the test, the configuration is such that the conductance of the calibration susceptor 7 is fixed and does not change throughout the test.

With this test, advantageously, testing equipment 1 may be calibrated before the real test.

Since the conductance of the calibration susceptor 7 is a known value X, the result Y given by the testing equipment 1 can then be adjusted based on such known value (the error being Y-X).

For example, the calibration susceptor 7 is configured to have a conductance value equal to 880 mS. If the output of the testing equipment is 881 mS, this means that the conductance value returned by the equipment 1 at the end of a test needs to be subtracted by 1 mS in order to be correct.

The calibration susceptor 7 acts as an offset for the testing equipment 1, and it is used for calibrating the testing equipment 1 before running the tests for testing the susceptor arrangements.

In FIG. 8 and FIG. 9 an open coil arrangement 129 is shown. In FIG. 8 an article 4 to be tested is about to be inserted into the coil arrangement 129 from the left side in FIG. 8. As may be seen in FIG. 9 the article is moved further into and partly through the coil arrangement to the right side in FIG. 9. The article 4 is moved into the cylindrical passage 21 in the coil arrangement 129 up to a measurement position. After testing, the article 4 is moved with a same linear movement out of the coil arrangement 129. Subsequent articles to be tested may be used to push previous articles forward. By this, little product handling is required for a subsequent or continuous testing of articles 4. Coil arrangements 129 for the present testing equipment may have an inductivity, for example, in a range between 120 nanohenry and 135 nanohenry, preferably, between 125 nanohenry and 130 nanohenry.

FIG. 10 and FIG. 11 show the coil arrangement 129 with electrical contacts 128 to provide the coil arrangement with power. In FIG. 10, the contacts 128 are arranged parallel to the passage 21 in the coil arrangement 129 to allow undisturbed insertion or passing of articles 4 through the coil arrangement. Also removal and insertion of the coil arrangement 129 into a control module is simplified by this contact arrangement. In FIG. 9 the electrical contacts 128 are bent by 90 degrees radially outwardly to establish electrical contact in the control module. The bent contacts allow the attachment, for example the soldering, of the coil arrangement 129 perpendicular to a PCB board for a vertical set-up of the coil and a vertical passing of articles through the coil arrangement 129.

FIG. 12 shows a testing equipment 1 with vertical passage 21 extending through the coil arrangement 129 in the control module 13 and through the control module. The control module 13 otherwise has a similar set-up as the control module described with respect to FIG. 3 comprising a PCB (Printed Circuited Board) 22 with the required components to measure physical characteristics of a susceptor arrangement in an article. The control module 13 is mounted on a support 15. The support 15 comprises an opening 150, which is aligned with the passage 21 through the control module 13. Tested articles may pass through the passage 21 and out of the control module 13 by gravitational force only.

FIG. 13 shows a modular set-up of two testing equipment 1 mounted in parallel. The vertical insertion direction of articles in each of the testing equipment 1 is shown with arrows. Even further testing equipment 1 may be arranged in parallel to enhance the number of tested articles per time.

Each of the two testing equipment 1 is provided with two control modules 13 arranged in series. Each of the control modules 13 comprises an open coil, wherein the passage in the open coil is arranged vertically and in line with each other. An article to be tested may thus pass both control modules of the same testing equipment 1.

A testing equipment with two serially arranged control modules 13 is schematically shown in FIG. 14. In the internal view of the testing equipment 1 in FIG. 14, the serial arrangement of the two coil arrangements 129 may be seen. One coil arrangement is arranged in the upper part of the testing equipment and the second coil arrangement 129 is arranged in the lower part of the testing equipment.

Two stoppers 25,26 are provided for stopping articles from further falling through the equipment. An upper stopper 25 is provided in about half the length of the testing equipment and a lower stopper 26 is provided at the end of the equipment, more precisely at the outlet end of the second coil arrangement 129.

This testing equipment is adapted to measure short articles, for example single-length articles, comprising a susceptor arrangement, wherein the susceptor arrangement may be positioned at either end of the article. If the article is inserted into the testing equipment with its susceptor arrangement at its upper end (directions given with respect to the vertical processing direction of the article) then the upper stopper 25 is actuated and the article is positioned in the upper control unit and measured using the upper control unit 13. If the article is inserted into the testing equipment with its susceptor arrangement at its lower end then the lower stopper 26 is actuated and the article is positioned in the lower control unit and measured using the lower control unit 13. By this, it is guaranteed that the susceptor arrangement in an article to be tested is always precisely positioned with a coil arrangement 129.

The testing equipment is also adapted to measure long articles, for example double-length articles, accordingly comprising two susceptor arrangements. The two susceptor arrangements are arranged at each end of the double-length article. If the double-length article is inserted into the testing equipment, lower stopper 26 is activated such that the two susceptor arrangements of the double-length article may be measured by the two coil arrangements. After a measurement has taken place, the respective stopper 25, 26 is withdrawn. The tested articles may fall downwards out of the testing equipment and make room for a next article to be tested.

Alternatively, or in addition to stoppers, also other forms of holding falling articles in the testing equipment may be used. Such holders may, for example, be clamps, for example, in the form of half-shells that may be opened and closed, clamping an article in between the shells.

FIG. 15 shows a set-up of a testing equipment 1 adapted to test falling articles 4 passing through the testing equipment 1. This set-up may, for example, be integrated into an article manufacturing process. For example, some of the manufactured articles may be bypassed and basically in-line be tested to check if they fulfill required quality specifications. It would also be possible to let all manufactured articles pass thought the testing equipment but select every now and then an article, which is tested. All other articles simply fall through the shown set-up without being tested.

A reservoir 40 in the form of a hopper contains a plurality of articles, for example elongate sticks carrying one or two susceptor arrangements to be tested. Preferably, the hopper may contain a few hundred stick, for example 200 to 300 sticks.

From the hopper, the articles 4 fall downwards and are positioned along a vertical line for example within a slide assembly arranged below the reservoir 40. Then the articles 4 reach the testing equipment 1. In the set-up the falling articles are guided to the passage 21 in the testing equipment. After passing through the excitation coil or excitation coils in the testing equipment 1, the tested articles leave the passage in the coils and pass through an indicator and selection portion 43 and subsequently into a container 44 collecting the articles.

The indicator and selection portion 43 may comprise sensors and, for example, indicator lights indicating results of the tested articles, for example acceptability of the tested articles.

The indicator lights may indicate, for example, the status of the testing equipment or if the tested articles are acceptable or defective by changing light colour. For example, one colour may indicate that the apparatus is ready for a measurement, that the measurement is ongoing, that a measured article is within product tolerances or that an article is outside product tolerances.

Preferably, test conditions are kept constant for an entire measurement cycle, for example over a certain number of tested articles or over a certain time of testing, for example over 24 hours. For example, test conditions comprise about 20 to 24 degree Celsius and about 40 to 60 percent relative humidity. An acceptable deviation from a desired electrical resistance is for example plus or minus 40 milliohms with an electrical resistance of between 300 to 450 milliohm of the susceptor element. The deviation is preferably determined relative to an average value over e.g. five measurements.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. A testing equipment for testing a susceptor arrangement in simulated heating conditions of a heated susceptor arrangement arranged in an aerosol-generating device during a user experience, the testing equipment comprising:
a holder module comprising a holder for receiving a susceptor arrangement to be tested;
a control module comprising an inductive heating arrangement and a measurement device comprising a control circuit; wherein the inductive heating arrangement is configured to generate an alternating magnetic field for inductively heating a susceptor arrangement;
wherein the measurement device is configured to determine values associated to physical characteristics of the susceptor arrangement from measurements related to a load applied to the control circuit responsive to a susceptor arrangement in operational communication with the inductive heating arrangement; and wherein the control circuit is configured to power the inductive heating arrangement for one test cycle or several subsequent test cycles of the susceptor arrangement and configured to determine if determined values associated to physical characteristics of the susceptor arrangement correspond to predetermined susceptor values.

2. The testing equipment according to claim 1, wherein the control module is configured to output acceptance of a tested susceptor assembly, if predetermined susceptor values are reached or to output rejection of a tested susceptor assembly, if predetermined susceptor values are not reached.

3. The testing equipment according to claim 1, wherein values associated to physical characteristics of the susceptor arrangement are apparent electrical conductance values and the predetermined susceptor values are predetermined electrical conductance values.

4. The testing equipment according to claim 1, wherein the holder comprises a cavity for receiving and accommodating a susceptor arrangement in the cavity.

5. The testing equipment according to claim 4, wherein at least one clip is arranged in the cavity for fixing a susceptor arrangement in the cavity.

6. The testing equipment according to claim 1, further comprising a cooling device for cooling a susceptor arrangement in between heating cycles.

7. The testing equipment according to claim 1, further comprising a support, wherein the holder module and the control module are mounted to the support, and wherein the holder module and the control module are relatively movable against each other on the support, such that at least parts of the holder in the holder module are accommodatable in and releasable from a respective receiving slot in the control module.

8. The testing equipment according to claim 1, further comprising a calibration susceptor for running a test cycle for determining a calibration factor for the testing equipment, the calibration susceptor having fix susceptor values, throughout a test cycle.

9. A method for testing a susceptor arrangement in a testing equipment in simulated heating conditions of a heated susceptor arrangement in an aerosol-generating device during a user experience, the method comprising:
providing a susceptor arrangement comprising at least a first susceptor material and a second susceptor material;
a) bringing the susceptor arrangement into operational communication with an inductive heating arrangement, and inductively heating the susceptor arrangement with the inductive heating arrangement;
b) determining values associated to physical characteristics of the susceptor arrangement from measurements related to a load applied to a control circuit, the measurements being responsive to the susceptor arrangement in operational communication with the inductive heating arrangement during a test cycle;
repeating steps a) and b); thereby determining values associated to physical characteristics of the susceptor arrangement for subsequent test cycles;
comparing determined values associated to physical characteristics of the tested susceptor arrangement with predetermined susceptor values;
accepting or rejecting the tested susceptor arrangement, if a difference between determined and predetermined susceptor values exceeds a predefined threshold.

10. The method according to claim 9, therein averaging determined values associated to physical characteristics of the susceptor arrangement over several or over all test cycles and comparing said averaged susceptor values with the predetermined susceptor values.

11. The method according to claim 9, where predetermined values associated to physical characteristics of the susceptor arrangement comprise a maximum and a minimum in electrical conductance per test cycle at predefined times during a test cycle.

12. The method according to claim 9, wherein the first susceptor material of the susceptor arrangement and the second susceptor material of the susceptor arrangement are in intimate physical contact with each other, wherein the second susceptor material comprises a Curie temperature of below 500 degree Celsius.

13. The method according to claim 9, wherein the first susceptor material comprises no Curie temperature.

14. The method according to claim 9, wherein the second susceptor material comprises or consists of a Ni—Fe-alloy comprising 75 weight percent to 85 weight percent Ni and 10 weight percent to 25 weight percent Fe.

15. The method according to claim 9, wherein the susceptor arrangement comprises a third susceptor material intimately coupled to the second susceptor material.

16. The testing equipment according to claim 1, further comprising a calibration susceptor for running a test cycle for determining a calibration factor for the testing equipment, the calibration susceptor having fix susceptor values comprising fix electrical conductance values, throughout a test cycle.

17. The method according to claim 9, where predetermined values associated to physical characteristics of the susceptor arrangement comprise a maximum and a minimum in electrical conductance per test cycle at predefined times during a test cycle, during a heating period of the test cycle.

18. The method according to claim 9, wherein the first susceptor material comprises a Curie temperature above 500 degree Celsius.
